(19) United States
(12) Patent Application Publication
(10) Pub. No.: US 2003/0136894 A1
(43) Pub. Date: Jul. 24, 2003

(54) Light receiving and detection system for reading a radiographic image

(76) Inventor: Richard Gerlach, Rolling Hills Estates, CA (US)

Correspondence Address: ROBERT J. SCHAAP, Suite 188, 21241 Ventura Boulevard, Woodland Hills, CA, 91364, US

(21) Appl. No.: 10/342,091

(22) Filed: Jan. 13, 2003

Related U.S. Application Data
(60) Provisional application No. 60/351,210, filed on Jan. 22, 2002.

(51) Int. Cl. G01J 1/20

(52) U.S. Cl. 250/201.1

(57) ABSTRACT

An apparatus and a method for receiving and detecting light from a plurality of light scanning operations on each scan line of a document, such as a radiographic image, which is being read. The light is detected by means of a photo-diode detector arrangement. Prior to detection, however, this light is received in an integrating arrangement. In effect, a progressive point of light from each optical fiber used for delivering of the light occurs from one end of a scan line to the other sequentially, from scan operation to scan operation. When the light emits from each of a plurality of optical fibers, the light then spreads somewhat into a cone. A reconcentrating and refocusing lens, such as a Selfoc lens, refocuses the spreading light into a point in the image plane of the radiographic film being scanned and essentially refocuses that light at that image plane. Detection of the light is made on a clock time basis so that the light content at each scan operation in a scan line so that recreation of the document is readily made.

### RELATED APPLICATION

This application is based upon, succeeds to and claims the benefits of priority of my U.S. Provisional Patent Application Serial No. 60/351,210, filed Jan. 14, 2002, and entitled “Light Detection System for Receiving Radiograph Image Data.”

### BACKGROUND OF THE INVENTION

1. Field of the Invention

This invention relates in general to certain new and useful improvements in a system for receiving light, such as laser light, passed through a radiographic image film containing an image thereon and which processes the light to effectively represent each scan line of a radiographic film being read. More particularly, the invention relates to a generally sealed optical system which can be manufactured relatively inexpensively and eliminates the need for an optical bench and does not result in any veiling glare. As such, the system is highly effective for use in the examination and digitizing of a radiographic image.

2. Brief Description of Related Art

In recent years, storage, retrieval and transmission of radiographic images has received widespread acceptance. Generally, images are obtained at a location, such as a site of a physician's office or a hospital. Images of this type may be taken for bone structure or used in an orthopedic treatment, a brain scan to determine if a tumor were present, and in a wide variety of other medical situations. Also frequently, these various different types of radiographic images require parties with differing skills to review and interpret the results of that radiographic image. Very frequently, the hospital or physician who generates the radiographic image may not have the necessary expertise, training or experience to properly evaluate that radiographic image, and hence, there is a need to obtain the services of a party who can interpret the image, and who may also be located at a remote site.

Very frequently, and as examples of the foregoing, hospitals and physicians located in small towns do not have the immediate availability of the services of a physician who has the capabilities of a radiologist, or other party having the capabilities of examining a particular type of radiographic image. They may, therefore, need to send that image to someone having such capabilities at a remote site. The use of a delivery service frequently involves days, and in some cases, interpretation of the image and treatment based thereon may be imminent.

In many cases, patients have had an image taken in one location and now find need to visit a physician in another location, and where the physician in that other location may have need to examine previous radiographic images to determine a history of a certain condition. In addition, with cruise ships and, for that matter, even military hospital ships, the physicians on those ships may not have the necessary capabilities of reviewing such radiographic images which are generated, and need to obtain input with respect to such radiographic images. Moreover, and in some cases, the input sought by a particular physician may be needed on an emergency basis, as aforesaid.

In many cases, the manufacturers of scanning devices which are used for the scanning of a radiographic image have relied upon that technology used in photocopiers. Unfortunately, the technology used in photocopiers does not easily translate into an efficient system for scanning of radiographic images. Numerous problems which arise with the use of photocopier technology is due to the simple, yet critical, fact that photocopier technology is based on the use of a substrate which is typically opaque, and usually the image on only one side thereof is scanned, whereas in radiographic images, the substrate is generally transparent.

In addition to the foregoing, the need for detail in scanning a paper was not nearly as critical as that in scanning a radiographic image, and insuring that all of the detail of that image was maintained in the scanning process. Prior art scanning systems, to the extent that they relied upon paper copier technology, were essentially rudimentary and not effective in generating high quality reproduction of images, and even more importantly, were not capable of generating those images without loss of detail.

Essentially all prior art radiographic image scanners heretofore employed relied upon an optical bench with a photomultiplier detector, using a gas laser as a light source. This complex array of precision lenses and mirrors in the optical bench provided surfaces which contributed to veiling glare as a result of edge reflections and surface contamination. They also relied upon a costly galvanometer to control raster scanning of the laser beam. These systems also utilized a photomultiplier which would degrade over time. The costly gas laser also degraded over time, and required periodic calibration and eventual replacement by qualified technicians. Consequently, the prior art laser scanning systems were not effective for generating true electrical representation of a radiographic image and transmitting same. Nevertheless, this is essentially the state of the technology which remains at present.

In connection with the system for delivery of light to a radiographic image, there was also a need to effectively detect that light passing through the radiographic image on a highly efficient basis. When the light passes through a radiographic film, there was a tendency for the light to scatter. Consequently, it is necessary to gather that light properly and uniformly. Otherwise, the quality of the image being detected for storage and transmission would be adversely affected.

Another problem with prior art detector systems was not only the need for constant readjustment and cleaning, but the fact that any substantial breakdown required personnel to service and repair that scanning apparatus. Frequently, service personnel were not available in numerous locations, as for example, small towns, oceangoing vessels, and the like. Consequently, the unit had to be shipped to a remote location for repair. There certainly has been a need for an optical detector system which can be made inexpensively, and discarded so that a new optical detector could be installed in a scanning apparatus without significant down time.

In my co-pending U.S. Utility Patent Application Serial No. ______, filed contemporaneously herewith and entitled “Light Distribution System for Scanning Radiographic Images,” there is described a system which utilizes laser light for successive energization of each of a plurality of optical fibers. In this way, each of the optical fibers are successively lighted, and successively distribute light to a light linearizing bar. Thus, the linearizing bar receives the ends of each of the optical fibers and effectively presents individual linearly aligned light emitting ends, and where the light carried by these optical fibers is then passed through the radiographic film or other document bearing a radiographic image. When the laser light passes through the radiographic document, it generates a light output on a pixel by pixel basis across each scan line of the document being examined, and successively thereafter examines each successive scan line of the document with a plurality of individual scan operations in each scan line. Each scan operation generates a pixel of light for use in reconstructing the radiographic image.

In the aforesaid system for delivering light from a laser light source to a light distributor, optical fibers are used, as aforesaid. There are a sufficient number of optical fibers for generating a plurality of successive scans in each scan line over the length of a document to be examined. Thus, as an example, the document is moved along its length so that the first line of the image is scanned and each successive line was scanned on a successive scan by scan basis. In each scan line there are a large number of scan operations across the width of that line. This required a large number of optical fibers, as for example, 3,600 optical fibers, for delivering light from a laser light source to a light distribution bar.

In accordance with the present invention, it is necessary to detect the light issued at that light bar and passed through the image. Moreover, this detection must be made without any significant scatter of light. It is therefore desirable to have the signal from every optical fiber detected, and then to have that light integrated.

### OBJECTS OF THE INVENTION

It is, therefore, one of the primary objects of the present invention to provide a radiographic image scanning apparatus, which uses an improved optical detector allowing for detection of light from each of a plurality of optical fibers, in which the light from those fibers is used for reading of the radiographic image.

It is another object of the present invention to provide an optical detector system for use with reading of a radiographic image, and which eliminates the need of an optical bench having a complex array of mirrors and lenses.

It is a further object of the present invention to provide an optical detector system of the type stated, which uses a laser light source for passing light through an image to be scanned and detecting that light with a closed detector system, such that problems of dust and dirt accumulation is avoided, and that veiling glare as a result of edge reflections and the like is eliminated.

It is an additional object of the present invention to provide an optical detector system which is highly effective in picking up light from each of a very large number of optical fibers, when that light has passed through a radiographic image without significant scatter of the light, thereby leading to an efficient optical reading of an image on a substrate.

It is another salient object of the present invention to provide a method of detecting light passing through a radiographic image from a light source, by using a series of aligned photo detectors, and which thereby eliminates the need for an optical bench with a complex array of lenses and mirrors.

It is still another object of the present invention to provide a digitizing scanning apparatus, which allows for detection of light from a light source in which the light passes through a radiographic image on a highly efficient basis, and which eliminates the need for costly repair and maintenance.

With the above and other objects in view, my invention resides in the novel features of form, construction, arrangement and combination of parts and components presently described and pointed out in the claims.

### BRIEF SUMMARY OF THE INVENTION

The present invention primarily relates, in a broad form, to the digitizing of a radiographic image for storage of electrical signals representative of that image, locating of the image and reproduction thereof, as well as long distance transmission, of such image. In this way, the image can be examined at a remote site. More particularly, the present invention relates to a system for detecting the light passing through that image, which is a relatively low cost system and is highly efficient in operation, and thereby substantially improves the quality of optical imaging of a radiographic image.

In accordance with the present invention, the term “radiographic image” is that image which may be taken by any of a variety of types of equipment, such as, for example, an x-ray, a magnetic resonance imaging system, or a topographic imaging system. Moreover, the image is preferably that of a medical image.

In a broad sense, light from a laser light source is introduced into a plurality of optical fibers forming part of an optical fiber bundle. The light successively introduced into each of these optical fibers is then introduced into a light linearizing bar. The light from that bar extends across the width of a document which is being scanned, and each optical fiber is successively energized for carrying light from the light source, so that the light passes through the radiographic image, and is then detected by the detector apparatus of the present invention.

The system for delivering of the light to the radiographic image and for passing through the radiographic image, is more fully illustrated and described in my earlier filed U.S. Provisional Patent Application Serial No. 60/351,209, filed Jan. 14, 2002, and in my co-pending U.S. Utility patent application Ser. No. ______, filed Jan. 13, 2003, and entitled “Light Distribution System for Scanning a Radiographic Image.”

In accordance with the present invention, it is necessary to detect the light which is successively passed through a radiographic image in a plurality of successively performed scan operations in each of a plurality of individual scan lines over the length of the document. Moreover, it is necessary to detect this light accurately on a pixel by pixel basis, and without any significant scatter of the light from the light bar which distributes the light.

In each document to be scanned and digitized, such as a radiographic film, a plurality of successive scan lines extending across the document in one dimension, such as the width of the document, are established. Each scan line extends essentially transversely across this dimension, e.g., the width of the document, as aforesaid, and there are a plurality of scan lines successively arranged over the other dimension such as, for example, the length of the document. In each scan line there will be a plurality of scan operations, that is, where an individual scan or sampling is made. Consequently, a plurality of successive scan operations will take place transversely across the width of the document, such that there may be several hundred or over several thousand successive scan operations which take place in each scan line. Each scan operation essentially results in the detection of a pixel of light and the number of pixels of light is also independent of the number of optical fibers.

The present invention thereby provides an elongate light detector bar located in spaced relation to a light distribution bar with the latter emitting light for passing through a radiographic image. The light detecting bar is provided with a plurality of photodetectors, as for example, photo-diodes, and with each photo-diode or other detector, preferably, although not necessarily, located to match an end of an optical fiber delivering light. Thus, in the present invention where 3,600 optical fibers used for delivering light, there would be an array of 3,600 photodetectors. Moreover, the light distribution bar and the optical detector bar would be located in relatively closely spaced relationship on opposite sides of the radiographic film, so that there is essentially little or no scatter of light.

The light from each optical fiber will impinge upon one or a few closely spaced photodetectors. Although there may be some slight scatter of light from each of the optical fibers as the light passes through the radiographic image, that scatter is not significant, and moreover, each optical sample is taken on a clock time basis, such that the amount of light at each optical sample is recorded on that clock time basis. In this way, the amount of light in each scan operation is positionally located on the image. Hence, the image can be easily electronically recreated therefrom.

In accordance with the present invention, the light from the light linearizing bar is then passed through an optical column or processing station comprised of a Selfoc lens and, possibly, a glass plate or other transparent plate, serving as a light guide, along with the Selfoc lens. In accordance with this arrangement, the light from each point source of light carried by an optical fiber is allowed to spread somewhat to a cone shaped output on the opposite side of the glass plate. The faces of the glass plate are highly polished so as to reduce the possibility of light scatter. The light is passed directly from this glass plate into a Selfoc lens without any space therebetween, such that all of the light passing through the glass also is introduced into the Selfoc lens.

It is also possible to use only the Selfoc lens, which is, in effect, a reconcentrating and refocusing lens, without the glass or other transparent plate, serving as a light guide. In the Selfoc lens, the light is effectively gathered from each filament point source, and refocused at the image plane of the x-ray film path, but generally as a point of light in the same form that the light exited the optical fiber.

The outputs of each Selfoc lens associated with each optical fiber are connected together so that there is, in effect, a collection of all of the information along the scan line, which is converted into an electrical analog signal. This analog signal from the scan line can then be digitized. In a sense, all of the photo-diodes thereupon become integrated into a type of optical integrating cylinder. At any given amplitude, the peak of the signal may vary, although, when graphically plotted on a clock time basis with clock signals on the clock track, there is a sampling of the light independently of the number of optical fibers emitting the light. The system provides an excellent optical path for recapture of most of the light from the light distribution bar, and the reading of the light through the substrate to obtain an accurate reproduction of pixel values of the image on that substrate.

In the detection of the light, each scan line of the substrate includes usually five to ten pixels, and generally, no more than ten pixels. In effect, each individual scan operation thereby produces a light effectively as a point source of light. In contrast, any prior art scan usually will involve several hundred pixels.

In as much as the invention also utilizes focused light cones, and not individual columns of light, there is no Moire pattern of light, and in addition, there is no constructive-destructive interference pattern of light.

One of the important aspects of the present invention is the fact that a Selfoc lens is used at the termination of the detection process. Without the use of this Selfoc lens there would be a destructive-constructive interference pattern, and the light would ultimately cancel itself out. In effect, by using the Selfoc lens immediately prior to the actual detection process, this destructive-construction light interference and canceling is removed. This is a result which was completely unexpected, and accounts for a significant advantage in the efficiency of light detection, in accordance with the present invention.

This invention possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not to be taken in a limiting sense.

### BRIEF DESCRIPTION OF THE DRAWINGS

Having thus described the invention in general terms, reference will now be made to the accompanying drawings (seven sheets) in which:

FIG. 1 is a schematic perspective view of a prior art laser scanning system, almost exclusively used in radiographic image detectors;

FIG. 2 is a perspective view of a scanning and digitizing apparatus, in accordance with the present invention;

FIG. 3 is an end elevational view showing the interior and the major components of the apparatus of the present invention, with a side plate thereof removed;

FIG. 4 is a front elevational view showing a light distribution system which can be used in the present invention, and with some of the components of the apparatus effectively eliminated in this FIG. 4, for purposes of clarity;

FIG. 5 is a somewhat schematic perspective view showing the delivery of light to a light distribution bar, and the gathering of that light and detection of that light, in accordance with the present invention;

FIG. 6A is a fragmentary schematic perspective view showing a light processing station, forming part of the detection system of the present invention and the light arrangement formed thereby;

FIG. 6B is a schematic side elevational view, showing the arrangement of the components in FIG. 6A and the light arrangement generated therewith;

FIG. 6C is a schematic view of a wave form of light passing through a light guide, which may be used in the arrangement of FIG. 6A and FIG. 6B in the present invention;

FIG. 7 is a fragmentary top plan view showing the arrangement of a light distribution bar and the light detector, along with a radiographic film used in accordance with the present invention;

FIG. 8 is a somewhat schematic plan view, substantially taken along the plane of line 8-8 of FIG. 5, showing the arrangement of light as it passes through the radiographic film, in accordance with the present invention;

FIG. 9 is a schematic top plan view, similar to FIG. 7, but showing a modified form of detection system, in accordance with the present invention;

FIG. 10 is a somewhat schematic plan view showing two of the major components forming part of the light processing arrangement of FIG. 9;

FIG. 11 is a schematic graphical view showing a wave form pattern at the output of the apparatus of the invention;

FIG. 12 is a fragmentary plan view showing details in the construction of the light detector strip of the present invention;

FIG. 13 is a fragmentary plan view of the opposite side of the detector strip shown in FIG. 12;

FIG. 14 is a schematic electrical diagram showing the electrical circuit arrangement of the detector of the present invention;

FIG. 15 is a graphical illustration showing the amount of light which was detected in any scan operation, using a lens and mirror prior art arrangement; and

FIG. 16 is a graphical illustration showing the amount of light which is detected in any scan operation, in accordance with the present invention.

### DETAILED DESCRIPTION OF A PREFERRED EMBODIMENT

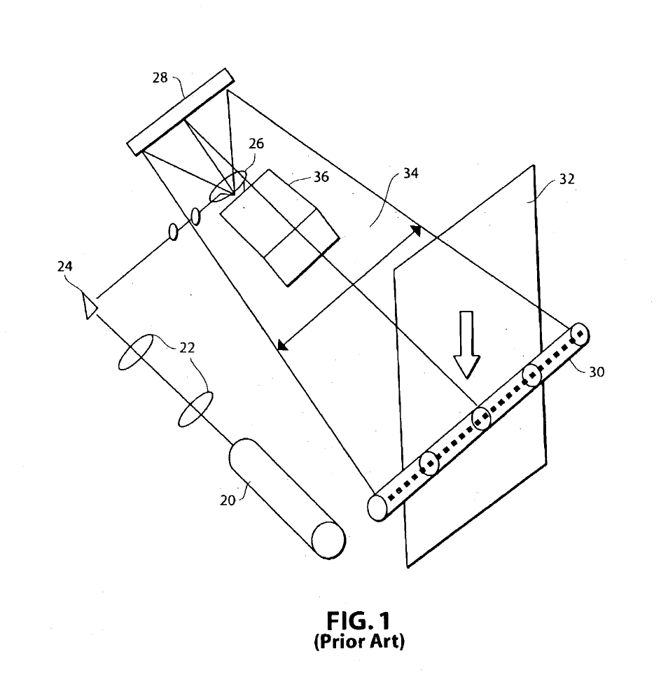

Referring now in more detail and by reference characters to the drawings, reference will initially be made to FIG. 1, which shows a typical prior art laser scanning system for scanning radiographic images. FIGS. 2-16 of the application more particularly relate to the apparatus and the method of the present invention.

Referring in more detail to FIG. 1, it can be observed that the prior art laser scanning systems generally rely upon a gas laser 20, including a plurality of condensing lenses 22, and a prism 24 directing light to a conical prism 26, and a folding mirror 28. That light from the mirror 28 is then directed to a photomultiplier detector 30. However, the light passes through the radiographic film substrate 32 and will thereupon provide a reading of the light and dark areas to the photomultiplier detector 30. The scanning beam generated at the folding mirror 28 is represented by the path 34. Moreover, a galvanometer 36 must be used in this arrangement to control raster scanning of the laser beam.

In substance, it can be observed that the prior art laser scanning systems, while being different from, nevertheless rely upon, technology similar to that used in conventional photocopiers. However, the prior art digitizing scanning systems, nevertheless, suffer from a large number of significant disadvantages, not the least of which is the high cost of expensive components coupled with high manufacturing costs.

Some of those expensive components, mentioned above, include the gas laser which is used since it degrades over time, requiring periodic calibration and eventual replacement. Usually, replacement is required every 2,000 to 5,000 hours, and usually by a qualified manufacturer-trained technician. The photomultiplier detector is also a costly item which similarly degrades over time, and also requires system re-calibration and eventual replacement. A galvanometer is costly and must be an accurate galvanometer to control raster scanning of the laser beam. This galvanometer also requires periodic calibration and very delicate adjustments. There is also a complex array of precision lenses and mirrors. Moreover, with these lenses and mirrors, every surface of same contribute to the veiling glare, as a result of edge reflections and surface contamination. The surface contamination is impossible to eliminate, and is typically caused by dust in the air. However, these mirrors and lenses require periodic cleaning and adjustment by trained technicians, or otherwise, pixel measurements are compromised.

Those disadvantages mentioned above are only some of the major disadvantages. However, it is noteworthy that there is down time due to the need for periodic cleaning and adjustment. In addition, a premature burn-out of, for example, the gas laser or photomultiplier could require early replacement. Although some manufacturers may provide a warranty policy, even that policy is expensive and adds to the overall cost of the system.

As indicated above, FIGS. 2-16 of the drawings more particularly illustrate both the apparatus and the method of the present invention. Returning now to FIGS. 2-13, A represents a radiographic image storage and retrieval apparatus, which includes an outer housing 40 having a front wall 42 and a top wall 44. A pair of plates 46 and 48 define a space for a feed slot 50 to receive a radiographic film substrate 52. The front wall 42 is also provided with an elongate exit slot 54 and a film receiving tray 56, to receive the film 52 after the same has been read and is discharged through the slot 54.

The apparatus is also provided on the outer housing 40 with a control panel 58, containing those controls necessary for the operation of the apparatus. These controls typically include an off-on switch, a speed control, and the like.

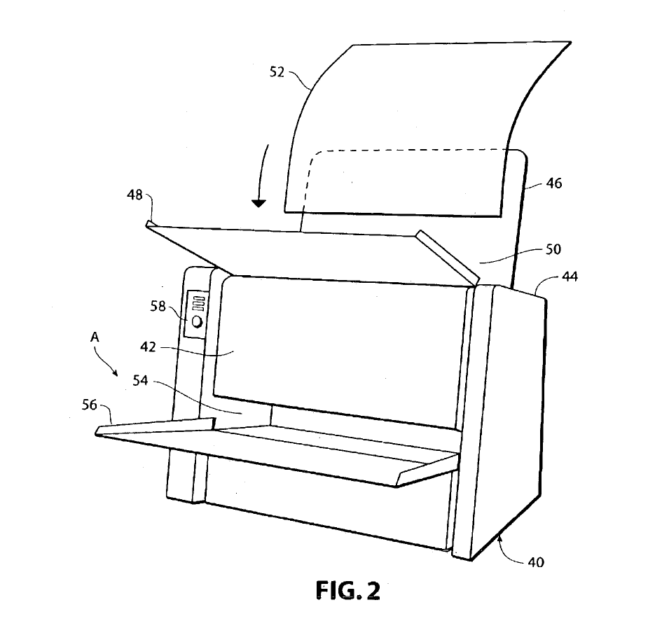

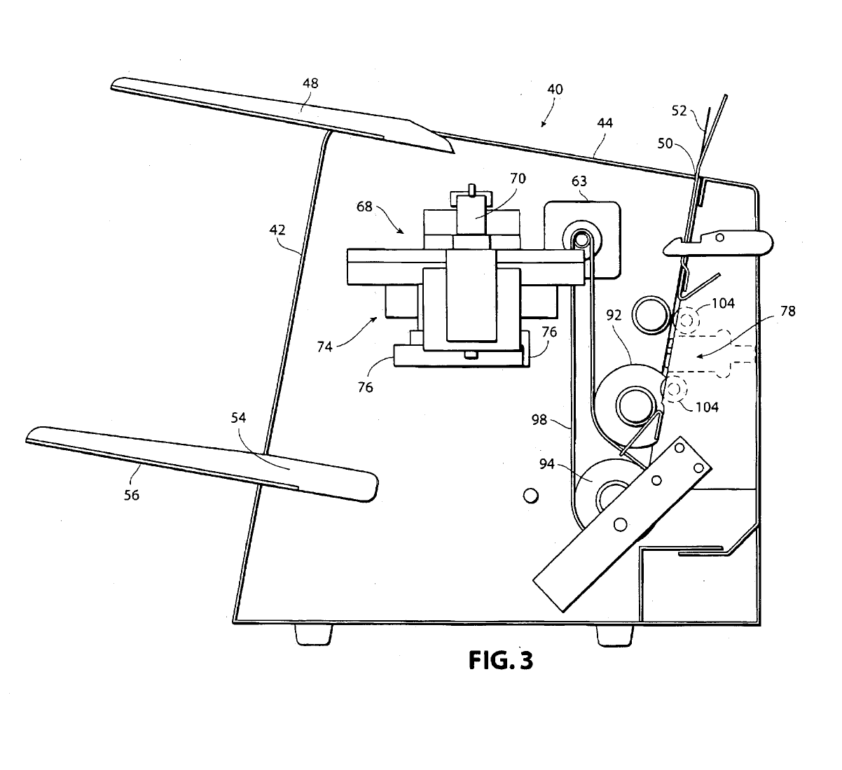

Referring now to FIG. 3, there is provided a drive system 60 for receiving the radiographic film, and moving same through the housing 40 of the apparatus. This drive system generally includes a drive roller 62 connected to an electrical motor 63, along with idler rollers 64. The actual drive mechanism is more fully described in my co-pending U.S. patent application Ser. No. 09/594,074, filed Jun. 12, 2002, entitled “Drive System for Digitizing Scanning Apparatus.” Although this particular drive system is not critical for use in the present invention, it certainly has been found to be beneficial, in that it represents an improvement over other prior art drive systems.

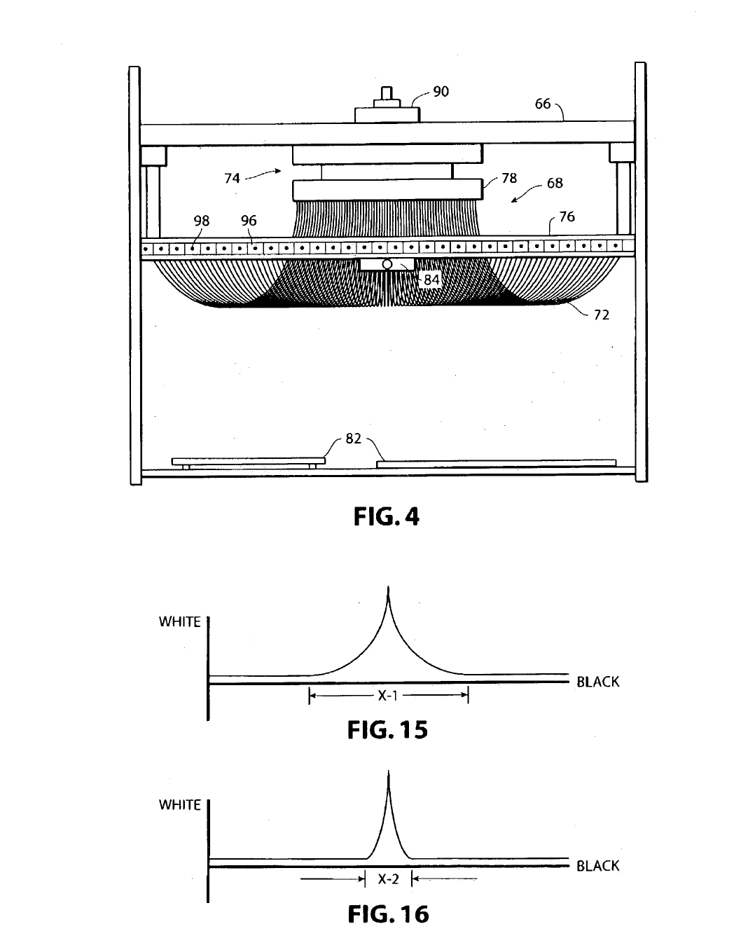

A horizontal support plate 66 mounted within the apparatus, as shown in FIG. 4, supports the laser light distribution system 68, which is one of the key components forming part of the apparatus of the present invention. This laser light distribution system includes a laser light source 70, a plurality of fiber optic cables 72, and a laser light feed mechanism 74. The laser light distribution system also includes a light linearizing distribution bar 76.

In brief summary, optical fibers are connected to a stationary plate 78, forming part of the light feed mechanism 74, and receives light from a light feed filament, hereinafter described, for distribution to each of the individual optical fibers 72. The light feed filament rotates around the ends of each of the individual fibers 72. These fibers 72 have first ends mounted on the plate 78 and second ends located at the rear side of the light distribution and linearizing bar 76. In this way, light from a rotating distribution feed is introduced into a linearizing distribution member for ultimate use. In particular, the light is passed through the film substrate 52 and detected by a reading and detector mechanism 77. As the film substrate 52 is moved past the light distribution bar 76 and the light detector 77, the light passing through the substrate 52 is detected and read for ultimate conversion to electrical signals for storage and retrieval.

The light distribution system is not the subject matter of the present invention, but is briefly described herein to show its relationship to and operation with the light reading and detection system of the invention. This light distribution system is more fully described and illustrated in my U.S. patent application Ser. No. ______, filed Jan. 13, 2003, and entitled “Light Distribution System for Scanning Radiographic Images,” and which is based on my U.S. Provisional Patent Application Serial No. 60/351,209, filed Jan. 14, 2002.

Also mounted within the housing of the apparatus are one or more electronic circuit boards 82, which control the actual operation of the apparatus. In addition, the apparatus could include its own internal power supply (not shown). In as much as the actual electronics is only that necessary for operating the drive system and, essentially, the optical system herein, it is neither illustrated nor described in any further detail herein. However, it is important to note that an encoder 84 also forms part of the apparatus, so that the light levels may be read on an encoded time basis.

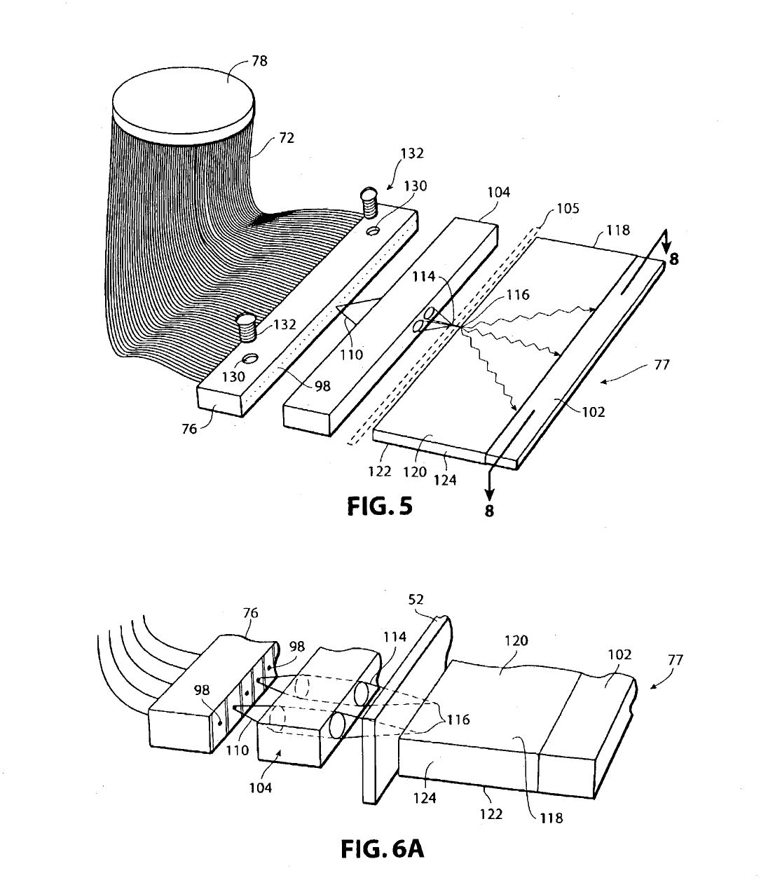

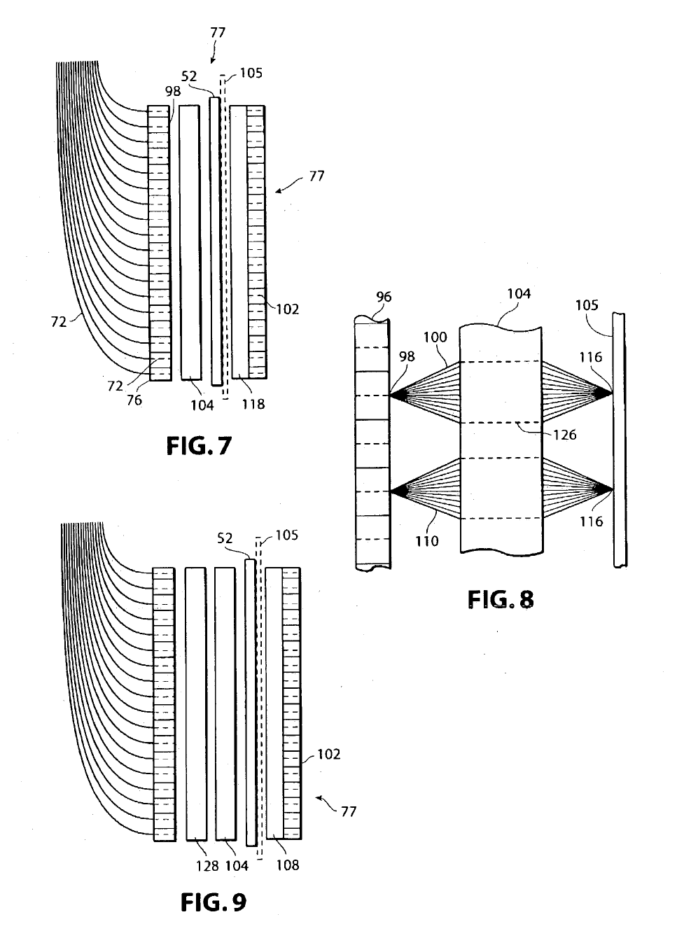

The following FIGS. 5-16 more specifically illustrate certain details of the light reading and detection mechanism 77, forming part of the apparatus of the invention. By reference to FIG. 5, it can be observed that the light receiving and detection system 77 of the invention comprises a light detecting bar 102, which is hereinafter described in more detail. The light which issues from each of the optical fibers 72 issues from ends designated as 98 in each of the optical fibers 72. By reference to FIGS. 7, 8 and 9, it can be observed that these ends 98 are all located in a linear array in the light distribution bar 76. Hence, the light which was initially issued from the light source to the first ends of the optical fibers 72, is then converted into a linear array.

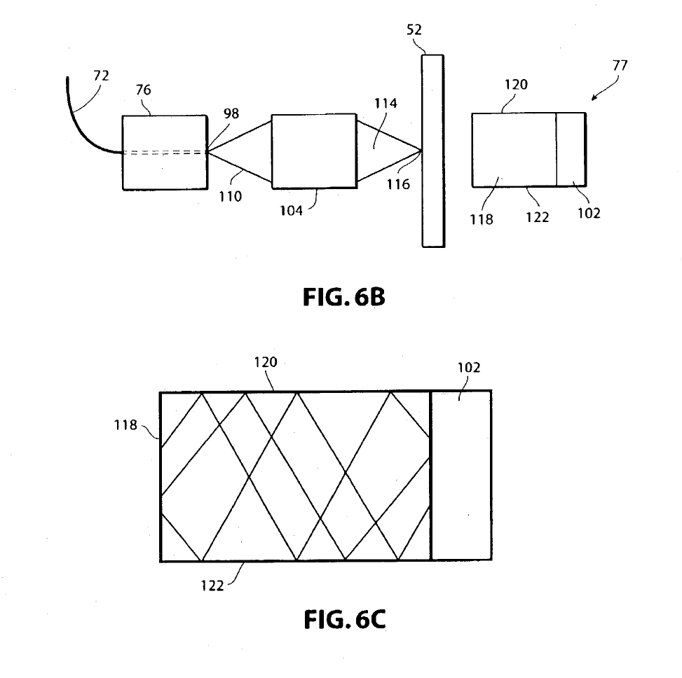

By further reference to FIGS. 5, 6A, 6B, 6C, 7 and 9, it can be observed that the light issuing from the light distribution bar 76 is then passed through a light processing station comprised of, at least, a light reconcentrating and refocusing lens 104, such as a Selfoc lens. The light passing through the Selfoc lens 104 is then introduced into the radiographic film 52 at a film plane 105 coplanar with the film 52. When the light passes through the radiographic film 52, it will then impinge upon a light detector bar 102, as shown in FIGS. 6A and 6B. It is possible to also use a light guide 118 prior to passing the light directly into the light detector 102. However, for most purposes, light passing through the radiographic film 52 will then impinge directly upon the light detector bar 102.

In accordance with the arrangement as shown, when a document to be scanned, such as a radiographic film 52, is passed between the linearizing bar 76 and an optical detector bar 102 forming part of the detector system 77, the light will pass through the radiographic film 52 and will be detected by the light detector bar 102. In actuality, the linearizing bar 76 and the light detector bar 102, have been shown as being spaced apart from the radiographic film 52, for purposes of clarity. However, in actual construction, they would be located in very closely spaced relationship to the radiographic film 52.

The light detector bar 102 is also linear, and has a number of photodetectors preferably, although not necessarily, equivalent to the number of optical fibers. Thus, in the case of the present invention, where 3,600 optical fibers are employed, the light detector bar 102 may include 3,600 individual photo detectors 104, also as best shown in FIG. 5.

It can be observed that while the light in each of the optical fibers is traveling throughout the length of the fibers, that light maintains somewhat of a colummated arrangement, such that it is capable of exiting the optical fiber at a point source. However, and by reference to FIGS. 5, 6A and 6B, it can be observed that when the light actually exits the light linearizing bar 76, it spreads out and forms a cone 110. Each point source of light from each of the optical fibers 72 will similarly form a cone shaped light, if the light was allowed to continue to spread. In this way, there would be a complete interference of the output light from one point source at the exit end 98 with each of the other point sources.

In order to preclude the formation of these individual cones of light 110 of any substantial size, and to maintain the integrity of the point source of light, the reconstituting and refocusing lens, often referred to as a “reconcentrating and refocusing” lens 102, is employed. In the more preferred embodiment, this lens 102 is a Selfoc lens. When the light travels through the Selfoc lens, it will exit in a cone 114 and be reconcentrated into another point 116 of light. In effect, the light will not be allowed to spread any further than the output side of the light cone 110. The Selfoc lens effectively takes each light cone 110, from each of the optical fibers 72, and reconstitutes that light source back into light points 116. These reconstituted light points will be located at a film plane 105, which is effectively an image plane coincident with the film substrate 52. In effect, the light which exits the light linearizing bar 76, has therefore been reconstituted back into that same light point at the film plane 105.

Located on the opposite side of the film plane and hence, on the opposite side of the image bearing substrate 52, is a light guide 118. In effect, the light guide 118 is approximately two inches wide in the direction of movement of the light. Located on the opposite side of the light guide 118, with respect to the film plane, is the light detector mechanism 77 comprising the light detector bar 102, the latter of which was heretofore described and which will also be hereinafter described in more detail. The light guide 118 also has a thickness of about 0.1 inch, although its depth in the plane of the light is about two inches. However, for purposes of clarity, the light guide has not been shown in proportional size relative to the components in FIGS. 6A and 6B.

The light guide has polished end surfaces 120 and 122. Also, preferably the end margins 114, are also preferably polished surfaces, and in effect, mirrored surfaces.

In accordance with the above construction, as light enters the light guide, it is allowed to disperse somewhat in the light guide, substantially in the form as best shown in FIGS. 5 and 6. However, since the surfaces of the light guide are polished surfaces, the light reflects back and forth within the light guide, as shown in FIG. 6C, and hence, there is essentially no loss of light. In other words, the same quantity of light which passed through the substrate 52 at the film plane, will similarly impinge upon the photo detector mechanism 77.

There is sufficient room for the light guide 118 to be associated with the output active surface of the light detecting bar 102. By reference to FIG. 6A and FIG. 6B, it can also be seen that there is only a very small dimension between the film plane and the surface of the light guide 114. In fact, that distance does not exceed 0.008 inches, and even more preferably, 0.005 inches. In this way, almost all of the light which exits the Selfoc lens associated with each output end 98 of an optical fiber 72 and passes through the substrate 52, will enter into the light guide 118.

FIG. 8 illustrates the actual spreading of the light exiting the end 98 of each of the optical fibers, to form the light cones 110. Moreover, it can be observed that as the light enters the Selfoc lens 104, it is constrained to move only in a given light path 126. In other words, the lens is constructed so that the light will not spread when it exits the lens 104. Thus, the light cannot scatter beyond that light path. At the outlet end, the lens 104 then refocuses that stream of light into that point source 116, as indicated above.

It is also possible to use a glass or similar transparent feed plate 128, located between the output ends 98 of each of the optical fibers 72, and the reconcentrating and refocusing lens 104, as shown in FIG. 9. Again, this plate would function as a light guide. This glass plate will also serve as a feed and will also constrain the light from expanding beyond the surfaces of the plate 128. For these purposes, the glass plate 128 is similarly provided with polished surfaces which permit only internal reflection, but not to permit any escape of the light from the plate.

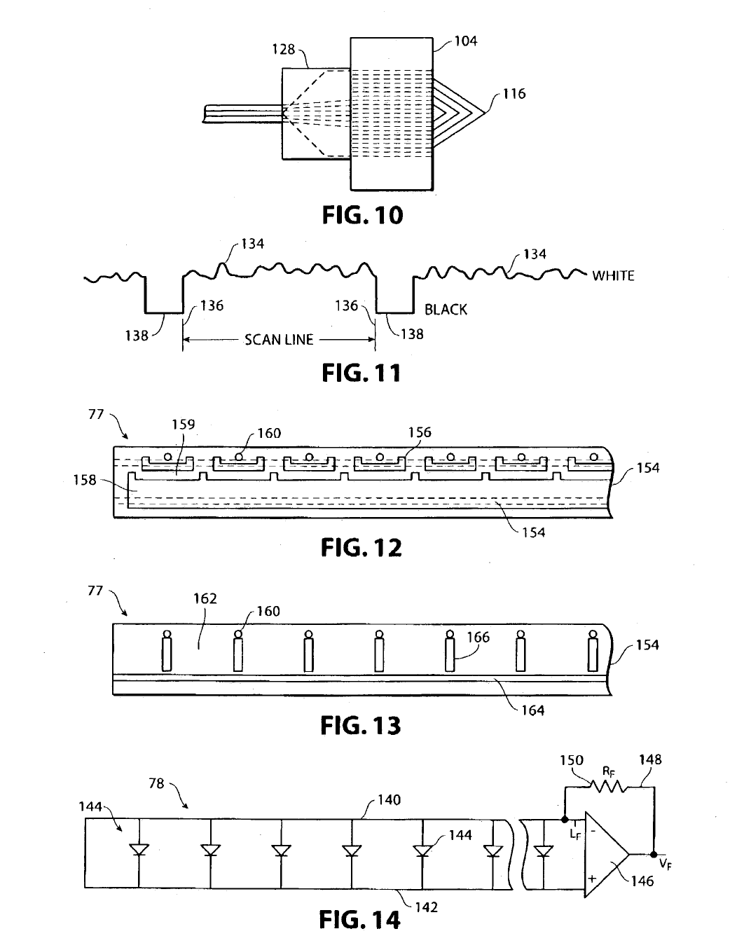

FIG. 10 illustrates the light pattern achieved when using the light guide 128 along with the reconcentrating and refocusing lens 104. Again, the light in the light guide 128 does not spread but enters directly into the lens 104.

In effect, it can be observed that the optical system from the light linearizing bar 76, at least to the film plane 105 and on the opposite side of the film plane 105, is essentially a sealed optical system. Obviously, there must be a slight dimension to accommodate films of differing thickness at the film plane. Nevertheless, the light which does exit the optical system at the film plane to pass through the radiographic film and the light collected on the other side, actually constitutes a sealed optical system. In this way, no dust or dirt accumulates within the system, and essentially does not require constant maintenance and cleaning, as with the prior art systems. Any surfaces which must be cleaned are easily accessible, as for example, by opening the backs of the housing and are not difficult to reach.

Returning again to FIG. 5, it can be observed that it is necessary to positionally adjust the light bar 76, so that the output ends 98 are closely spaced with respect to the light reconstituting and refocusing lens 104. A very simple, but nevertheless, highly effective adjustment system has been provided for this purpose. It can be observed that since the position of the Selfoc lens should be maintained relative to the film plane, adjustment of the position of the linearizing light bar 76 should be provided. For this purpose, the linearizing light bar 76 is provided with elongate screw receiving apertures 130, which are sized to receive screws 132 having offset pins or shanks. Thus, as the screw is turned within the elongate apertures 130, they will cause a shifting movement of each of the opposite ends of the linearizing light bar. Thus, it is possible to position either end, or both of the ends, closer to the reconcentrating and refocusing lens 104. In this way, a very simple, but nevertheless, effective adjustment system has been provided.

Referring now to FIG. 11, it can be observed that at each scan operation, there is a ripple or waveform 134 representing the various levels of light which are measured during that scan operation. In effect, the light from one optical fiber could spill over while there is a scan operation being performed with the next adjacent optical fiber. During that measurement, there will be generally white light. However, the amount of that light can vary, depending upon the opaqueness of that portion of the image which is being examined and the spillover light. It can be observed that in between each scan operation, as shown by 136 in FIG. 11, there will be a complete black signal 136. The area defined by the reference lines 136 represents the scan line or period of each scan.

The photo detector 78 is essentially comprised of a series of photo-diodes. In order to provide a high degree of sensitivity, there could be a number of photo-diodes equal to the number of optical fibers. Thus, in the embodiment of the invention where there are 3,600 optical fibers, as aforesaid, there would also be, in effect, 3,600 photo-diodes. Although the number of diodes does not have to equal the number of optical fibers, this arrangement is preferred. As indicated, it is not necessary to have the same number of photo-diodes, inasmuch as the encoder determines, on a clock time basis, the amount of light measured at each scan operation, and the specific point on the document in which that scan operation took place, in each scan line of the document. In other words, when a scan operation is conducted, the amount of light, and hence, the pixel for that particular point on the document is effectively recorded. Thus, in the recreation of the document, that amount of light will be recreated in the reproduction of the image. Hence, with all of the pixels thus recorded, a fairly accurate and high resolution reproduction can be achieved.

In effect, during each scan operation, there will be a ripple effect depending upon the amount of light which passes through the film, and therefore, the light which, is received at the detector 77. That amount of light which impinges upon the detector bar will vary in accordance with the degree of opaqueness or transparency of certain portions of the image on the radiographic film. In as much as there are 3,600 optical fibers, every one of the fibers is illuminated with no more than plus or minus ten percent of the light passing through that optical fiber. This is in substantial contrast to forty to forty five percent of the light which would enter into a detector from an optical film, in the prior art systems. In this way, it is possible to take that signal in an analog output format, and easily and readily convert that to a digital format, such that the digital format essentially looks like the analog format. Heretofore, this was not possible.

FIGS. 15 and 16 also show the comparison of the amount of light measured in a scan. In any prior art system, the amount of light actually measured, that is, the white light compared to an opaqueness or black, had a substantial width shown as X−1, in FIG. 15. In other words, there was a large amount of white light from other scans which materially interfered with any particular scan operation, and hence, the ultimate resolution and accuracy of the reproduced image. However, in contrast, and in accordance with the present invention, the amount of light in any scan is that shown by X−2. In effect, the distance X−1 actually represented several hundred pixels. In contrast, and in the present invention, the distance X−2 essentially represents no more than about ten pixels, and usually within the range of five to ten pixels. Consequently, it can be seen that the resolution obtained with the system of the present invention is significantly greater than that which was obtained in the prior art.

FIG. 14 illustrates an electrical representation of a photo detector, in accordance with the present invention. For this purpose, there is provided a photo current line 140 and a ground line 142, across which a plurality of photo-diodes 144 are connected. At their output ends, the two conductors 140 and 142 connected across an amplifier 146. The conductor 140 would be connected to the negative input of that amplifier and the conductor 142, which is effectively a ground line, would be connected to the positive input of the amplifier. A feedback loop 148 is also established across the amplifier, and includes a resistor 150.

It can be observed that the conductor 140 will effectively carry that current which is generated at a particular diode 144. That current is designated by i_{f}. The resistance 150 would have a value of R_{f}. Hence, the output voltage would have a value of V_{f}. In effect, the output voltage is a product of the current and the negative factor of the resistance, according to the following arrangement:

V_{f}=(−R_{f})i_{f}

FIGS. 12 and 13 illustrate one preferred embodiment in the method of making the optical detector 77, of the present invention. In this case, the optical detector 77 comprises a printed circuit board 154 with a plurality of optical detector elements or chips 156 on the top side thereof, in the manner as shown in FIG. 12. There is also an electrically insulative section 158, which defines recessed areas 159 for receiving each of the detector chips 156. Preferably, there are a number of detector chips 156 equal to the number of optical fibers, although as indicated above, this is not absolutely critical. Extending through the circuit board in the location of each of the optical detector chips 146, are conductive pins 160. These pins 160 extend to the opposite side or the bottom side 162, of the circuit board as shown in FIG. 13. In addition, there is a ground line 160. Conductive strips 164 connect each of the pins 150 with the ground line 154, and thereby complete a circuit.

In accordance with the above defined construction, it can be seen that it is fairly convenient and easy to actually reposition the chips 156 on the circuit board 144. In this way, the circuit board or photodetector 77 can literally be mounted in the apparatus, and with simple adjustment being made while the device is physically mounted in the apparatus of the digitizing, scanning and detecting apparatus of the present invention.

In connection with the description of the photo-diode circuit, it can be observed that by using the construction described above, it is possible to test each photo cell, that is, to test each photo-diode first, before the same is actually soldered to the circuit board. Thus, if the photo-diode proves to be inaccurate or ineffective, it can merely be discarded, rather than if it were soldered to the board initially.

The apparatus and the method of the present invention provide significant advantages in terms of light distribution and scanning, which is not even remotely achievable by the typical prior art scanning system using lenses and mirrors along with a photomultiplier tube. In effect, the system of the present invention provides almost perfect geometric arrangement to within plus or minus one pixel, and this is true even over the scan width of a full fourteen by seventeen inch radiographic film. In addition, the optical system of the present invention is sealed. In effect, there is a clean exit surface on the Selfoc lens and a clean entrance surface on the light side of the Selfoc lens. Moreover, the system of the invention is arranged so that there is no need for periodic adjustment. Once the light bar is adjusted, as aforesaid, there is no need for any further adjustment of the components of this system. This is in great contrast to prior art optical benches, in which the mirror and lens surfaces frequently and rapidly collect dust and dirt and must be cleaned.

One of the advantages of the system of the present invention is that the entire device can be manufactured at a relatively low cost. In addition, it is highly toolable for mass production operation through the way that the apparatus is constructed. Thus, in the event of a failure of any one component, the entire system can be swaped, so that there is no need for onsite servicing.

Another significant advantage of the present invention is the fact that there is no veiling glare. In the prior art systems, several hundred pixels in each scan are affected by the glare and this materially reduces the accuracy of the reading. In the case of the present invention, and as shown in FIGS. 15 and 16, there is essentially no more than five to ten pixel scatter in every point source of light in a scan operation. Moreover, because of this, not only is there no veiling glare, there is no Moire pattern along with a typical destructive-constructive interference of light.

The laser light distribution system of the invention also provides for both perfect rotation in both the X axis and the Y axis for distributing light from the laser light source to each of the optical fibers. Moreover, by use of an accurate motor, the velocity of light distribution is highly constant. Moreover, the encoder can be coupled to the output shaft of the electric motor, thereby providing a high density clock track with high resolution sampling. In this way, a plus or minus one pixel geometry can be obtained over the entire film.

As indicated previously, there is no veiling glare obtained, and hence, resolution is far more accurate. There is also no cosine-4 power roll-off, and the geometry is perfect linearly from side to side. The focused output of the light eliminates all Newton interference patterns.

As a result of the advantages achieved by the present invention, there is not only superior image quality, but there is superior reliability with fewer, if any, service calls required. The device is highly manufacturable, and moreover, produceable at a low cost. This, in and of itself, also provides for easier shipment of the device.

The apparatus of the invention is highly accurate to plus or minus one pixel over both the X axis and the Y axis for an entire radiographic film. Resolution of up to more than 3,000 pixels per scan line, that is, 116 million pixels per scan line, can also be obtained with a 16 bit gray scale.

The apparatus is capable of operating in differing speed modes, and with a variety of different sized films. The apparatus can accept and process a film sheet of up to fourteen inches by seventeen inches. Moreover, it can process this film in a 1k scan mode in thirteen seconds, a 2k scan mode in twenty six seconds, with a 3k scan mode in thirty nine seconds.

Thus, there has been illustrated and described a unique and novel light receiving and detection system for reading a radiographic images, and which thereby fulfills all of the objects and advantages which have been sought. It should be understood that many changes, modifications, variations and other uses and applications which will become apparent to those skilled in the art after considering the specification and the accompanying drawings. Therefore, any and all such changes, modifications, variations and other uses and applications which do not depart from the spirit and scope of the invention are deemed to be covered by the invention.

Having thus described the invention, what I desire to claim and secure by Letters Patent is:

1. A light processing system for processing light used in scanning of an image on a substrate, said system comprising:
a) means for distributing light from a light source successively to each of an array of light conduits and where the light exists in a point source at the ends of each of the conduits, and where the light spreads into a cone after passing through the ends of the conduits;
b) reconcentrating and refocusing lens means for reconcentrating and refocusing the spread cone of light at an image plane to essentially represent the form of light as it exited each of the conduits so that the light from each conduit can accurately identify a pixel of light in a reproduction of the image being scanned; and
c) directing the reconcentrated and refocused light to a light detector to allow for conversion of the detected light to an equivalent electrical signal, whereby each electrical thus produced enables regeneration of the image on the substrate.

2. The light processing system of claim 1 further characterized in that each of the light conduits are optical fibers.

3. The light processing system of claim 2 further characterized in that the array of optical fibers are located in a linear array at the point where the light exits the fibers.

4. The light processing system of claim 3 further characterized in that the fibers are initially in an arcuately shaped array to allow for successive distribution of light to a large number of the optical fibers and are thereafter converted to a linear array.

5. The light processing system of claim 1 further characterized in that a light guide is located in close relationship to the concentrating lens means and in front of an active surface of the detector to guide the light through the guide to the concentrating lens and to the detector in substantially the same form as it existed after passing through the substrate.

6. The light processing system of claim 5 further characterized in that the reconcentrating and refocusing lens is a Selfoc lens.

7. The light processing system of claim 6 further characterized in that said light guide has polished surfaces so that it allows the light to be internally reflected within the light guide but to exit with a distribution substantially no larger than when it passed through the reconcentrating and refocusing lens.

8. The light processing system of claim 5 further characterized in that the light guide is a transparent glass plate with polished surfaces and is located on the front side of said reconcentrating and refocusing lens and in contacting relationship therewith.

9. The light processing system of claim 4 further characterized in that the light from each of the optical fibers is introduced into a linearizing bar which receives the exit ends of each of the optical fibers and causes a linear array of each of the light outputs from the optical fibers.

10. The light processing system of claim 1 further characterized in that said light processing system is used in the reading of a radiographic image and said substrate comprises a film with the image thereon being a medical image.

11. A method for processing light used in the scanning of an image on a substrate in a system relatively free of lenses and mirrors, said method comprising:
a) providing a source of light;
b) distributing the light in concentrated columns of the light and successively to each of an array of light carrying conduits and where the light spreads after passing through ends of the conduits;
c) reconcentrating and refocusing the light at an image plane in which an image is going to be scanned and read to essentially represent the original concentrated column form of light from each of the conduits;
d) allowing the light from each of the conduits to identify a pixel of light in a reproduction of the image which is scanned; and
e) directing the reconstructed and refocused light to a light detector to allow for conversion of the detected light to an equivalent electrical signal.

12. The method of processing light of claim 11 further characterized in that the electrical signals which are produced are in analog signal format and the method comprises converting the analog signal to an equivalent digital signal for purposes of storage, locating and reproduction.

13. The method of processing light of claim 11 further characterized in that the method comprises introducing the colummated light in an optical delivery fiber which functions as the light conduit.

14. The method of processing light of claim 11 further characterized in that the method comprises distributing the light to a circular array of the fibers initially and linearizing the fibers so that the light exits at a linear array.

15. The method of processing light of claim 11 further characterized in that the light which is detected is first introduced into a light guide allowing the light to travel only through the light guide, directly to a reconcentrating and refocusing lens so that the light is in substantially the same form as it existed after passing through a substrate bearing the image.

16. The method of processing light of claim 11 further characterized in that the method comprises the reading and scanning of a radiographic image and the substrate having that image comprises a radiographic film and with the image being that of a medical image.

17. A method of reconstituting and refocusing at a substrate image plane that light which is successively issued from a plurality of small diameter light carrying conduits, said method comprising:
a) a passing light through each of a plurality of optical fibers and where the light tends to spread into a light cone having a point source at the output of each of said fibers;
b) introducing the light into a reconcentrating and refocusing lens so that the light is reconcentrated back into a point source at the image plane and essentially adopting the form in which it existed in that point source at the output of each said fiber; and
c) simultaneously with the reconcentrating the light back into a point source also refocusing that light from each optical fiber at that image plane.

18. The method of reconstructing and refocusing of claim 17 further characterized in that said method comprises introducing the light into the light detector of a radiographic imaging system to generate equivalent electrical signals.

19. The method of reconstructing and refocusing of claim 18 further characterized in that the method comprises passing the light through the reconcentrating and refocusing lens and then through a radiographic image to scan same and thereafter introducing the light into a light detector.

20. The method of reconstructing and refocusing of claim 19 further characterized in that the method comprises passing the light through a light guide before the reconcentrating and refocusing lens and allowing for internal reflection of the light in the light guide but substantially very little loss of light from the light guide.

21. The method of reconstructing and refocusing of claim 17 further characterized in that the method further comprises introducing light into a light linearizing member before introducing into the reconcentrating and refocusing lens and positionally adjusting the position of the light linearizing member and the lens by turning offset screws in one of the member or lens.

22. A method of making and allowing for testing and adjustment of a photodetector having a plurality of photodetector cells therein, said method comprising:
a) providing an electrically insulative surface section on a first surface of an elongate circuit board with non-insulative areas which receive photodetector cells;
b) providing conductive pins extending through said circuit board from said first surface to a second and opposite surface thereon;
c) providing a ground line on said second surface but spaced from the region of the photocells;
d) providing conductor strips from said pins to said ground line; and
e) placing the photodetector cells on said board in the non-insulative areas and adjusting the positioning of the cells before securing the cells to the circuit board.

23. The method of making and allowing for testing and adjustment of claim 22 further characterized in that said method comprises soldering the photodetector cells to the circuit board after they have been adjustably positioned thereon.

24. The method of making and allowing for testing and adjustment of claim 22 further characterized in that said method comprises connecting an amplifier across said ground line and said photodetector cells.
